(19) United States
(12) Patent Application Publication
(10) Pub. No.: US 2010/0232142 A1
(43) Pub. Date: Sep. 16, 2010

(54) Condensing film for LCD backlight unit and LCD backlight unit using the same

(75) Inventors: Kyung Mo Kim, Daejeon (KR); Kwang Seung Park, Daejeon (KR); Jin Hyun Kim, Incheon (KR); Sang-Choll Han, Daejeon (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/308,377

(22) PCT Filed: Apr. 18, 2008
(86) PCT No.: PCT/KR2008/002211

§ 371 Date: Dec. 12, 2008

(30) Foreign Application Priority Data
Apr. 20, 2007 (KR) 10-2007-0039001

(51) Int. Cl. G02F 1/13357; G02B 19/00

(52) U.S. Cl. 362/97.2; 359/599

(57) ABSTRACT

There is provided a condensing film for an LCD backlight unit. The condensing film including a film unit; a light outgoing unit formed in an upper surface of the film unit; and a light ingoing unit formed in a lower surface of the film unit, wherein a light diffuser is included inside the condensing film. The condensing film may be useful to widen a viewing angle and prevent the formation of hot bands by improving luminance distribution characteristics of light emitted from the condensing film since the condensing film includes a light diffuser capable of diffusing the light.

### TECHNICAL FIELD

The present invention relates to a condensing film used in an LCD backlight unit, and more particularly, to a condensing film for an LCD backlight unit that is designed to solve problems regarding the narrow viewing angle and the formation of hot bands since a light diffuser is included inside the film.

### BACKGROUND ART

In general, a liquid crystal display (LCD) is a device to display an image by injecting a liquid crystal material between an upper substrate having a common electrode and a color filter formed therein and a lower substrate having a thin film transistor and a pixel electrode formed therein, changing arrangement of liquid crystal molecules by applying different electric potentials to the pixel electrode and the common electrode to form an electric field, and controlling transmittance of light through the re-arranged liquid crystal molecules.

LCD has advantages that it may be manufactured with small scale and light weight and driven at low power consumption. Therefore, the LCD has come into the spotlight as an alternative image display unit that is able to solve the problems of the conventional Braun tube (cathode ray tube), and has been used for almost all the image display devices.

However, since an LCD device is used as a passive device that does not spontaneously emit light, a backlight unit for providing light to a panel should be provided in a lower portion of the panel. Backlight units are divided into an edge-type backlight unit and a direct-type backlight unit according to the position of a light source, and includes a light source and a plurality of optical films stacked on the light source.

FIGS. 1A and 1B are diagrams illustrating a configuration of a conventional backlight unit. Here, FIG. 1A shows a direct-type backlight unit, and FIG. 1B shows an edge-type backlight unit.

As shown in FIG. 1A, the conventional direct-type backlight unit includes a light source 1; a diffusion plate 2 mounted on the light source 1; and optical films such as a first diffusion film 3, a condensing film 4 and a second diffusion film 5 all of which are sequentially stacked on the diffusion plate 2. In this case, the diffusion plate 2 functions to conceal a light source by converting parallel line light sources 1 into a surface light source, the condensing film 4 functions to focus light within a visible range, the light being passed through the diffusion plate 2 and the first diffusion film 3 and diffused out in various directions. In this case, the first diffusion film 3 functions to reinforce the concealing function and support the function of the condensing film 4, and the second diffusion film functions to soften luminance distribution of the light emitted, from the condensing film 4.

Meanwhile, the edge-type backlight unit also includes a light source 1, a light guide plate 2 uniformly deflecting the light emitted from the light source 1 in one direction toward a viewer, and optical films such as a first diffusion film 3, a condensing film 4 and a second diffusion film 5, all of which are stacked on the light guide plate 2 as shown in FIG. 1B.

As described above, a large number of optical films were used in the conventional LCD backlight unit to display an image with excellent image quality, and other various optical films, in addition to the above-mentioned optical films, were further used to correct a viewing angle or improve the luminance.

However, the increase in the number of the stacked optical films makes it possible to improve the image quality, but this results in problems that the production cost of the backlight unit is high and the LCD device is increased in volume. Therefore, there is an increasing demand for developing a backlight unit that display an image with excellent image quality without the use of many optical films and whose manufacturing cost is low.

### DISCLOSURE OF INVENTION

### Technical Problem

The present invention is designed to solve the problems of the prior art, and therefore it is an object of the present invention to provide a backlight unit capable of reducing the manufacturing cost by providing a condensing film designed to be used alone without any diffusion film.

### Technical Solution

According to an aspect of the present invention, there is provided a condensing film for an LCD backlight unit including a film unit; a light outgoing unit formed in an upper surface of the film unit; and a light ingoing unit formed in a lower surface of the film unit, wherein a light diffuser is included inside the condensing film.

In this case, the light outgoing unit may be composed of lenticular lenses, and the light ingoing unit may have a prominence-depression pattern whose prominences are formed at constant distances, and reflection planes may be formed in the prominences of the prominence-depression pattern.

Meanwhile, a polymer film made of a material such as polyester, polyvinyl chloride, polycarbonate, polymethylmethacrylate, polystyrene, polyesthersulfone, polybutadiene, polyetherketone and polyurethane may be used as the film unit, and the light outgoing unit and the light ingoing unit may be manufactured using a curable resin.

Also, the light diffuser may have a mean particle diameter of 1 to 10 μm (micrometer), and it is desirable to use a bead-type spherical particle having a refractive index difference of about 0.01 to 0.1 relative to an inner part of the condensing film.

As shown by a reference numeral 4 in FIG. 1, the condensing film that have been used in the conventional backlight unit has a lenticular lens formed in an upper surface thereof and a reflector layer formed in a lower surface thereof, wherein an opening through which light is passed is formed in the reflector layer. The light enters the condensing film through the opening, and then is focused by the lenticular lens formed in an upper surface of the backlight unit.

FIG. 2 is a graph illustrating a luminance distribution of light at a vertical axis according to the viewing angle of the light passed through a condensing film. As shown in FIG. 2, it is revealed that a region where the luminance distribution is sharply changed according to the viewing angle is formed when the light is passed through the conventional condensing film. Owing to the optical characteristics, a hot band phenomenon, in which a boundary between light and shade appears at the viewing angle where the luminance distribution is sharply changed, occurs in the conventional condensing film, which leads to the deteriorated image quality of LCD. For the purpose of solving the above problems, one method has been used in the art, including: relieving the change in luminance by passing light, passed through a condensing film, through a diffusion film. However, the backlight unit has the problem that its manufacturing cost is high and its volume is increased with the increase in the number of the used optical films, as described above. For the present invention, a condensing film that may be used alone without any diffusion film is provided since a light diffuser for diffusing light is included in the condensing film. For the present invention, a backlight unit that is economical and has excellent performances due to the presence of the condensing film is also provided.

### Advantageous Effects

The LCD backlight unit according to the present invention may be useful to widen a viewing angle and prevent the formation of hot bands by improving luminance distribution characteristics of light emitted from the condensing film since a light diffuser for diffusing the light is included inside the condensing film.

Also, the LCD backlight unit according to the present invention may be useful to easily form reflection planes with a reflectance UV ink by forming a prominence-depression pattern in the light ingoing unit.

In addition, the LCD backlight unit according to the present invention may be useful to manufacture a condensing film having a desired shape, size or pitch using a method such as molding and simplify the manufacturing process since the light ingoing/outgoing units are made of a curable resin according to the present invention.

Furthermore, the LCD backlight unit according to the present invention may be useful to reduce the production cost since there is no need to mount a diffusion film in the backlight unit in which the condensing film of the present invention is mounted.

### BRIEF DESCRIPTION OF THE DRAWINGS

FIGS. 1A and 1B are diagrams illustrating a conventional backlight unit.

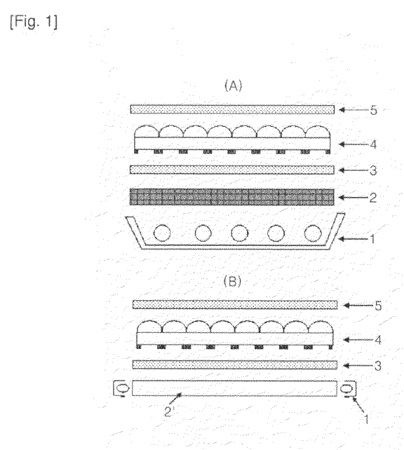

FIG. 2 is a graph illustrating a luminance distribution according to the viewing angle of a condensing film.

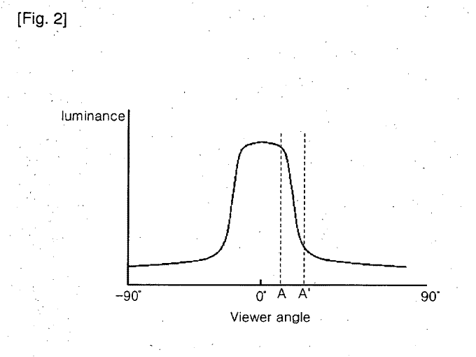

FIG. 3 is a diagram illustrating a configuration of a condensing film according to the present invention.

FIGS. 4A, 4B and 4C are diagrams illustrating a condensing film including a light diffuser according to the present invention.

FIG. 5 is a graph illustrating the luminance distributions obtained by comparing the condensing film according to the present invention with the conventional condensing film.

### BEST MODE FOR CARRYING OUT THE INVENTION

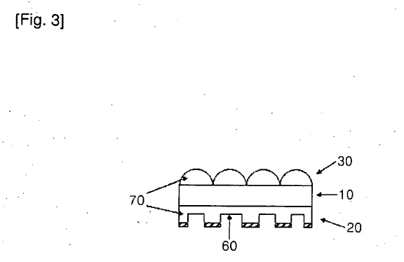

Hereinafter, the condensing film for an LCD backlight unit according to the present invention will be described in more detail with reference to FIG. 3. FIG. 3 shows a condensing film according to the present invention. As shown in FIG. 3, the condensing film according to the present invention comprises a film unit 10, a light ingoing unit 20 and a light outgoing unit 30.

The film unit 10 functions to support the light ingoing unit 20 and the light outgoing unit 30 as described later, and may be composed of a polyester film, a polyvinyl chloride film, a polycarbonate film, a polymethylmethacrylate film, a polystyrene film, a polyesthersulfone film, a polybutadiene film, a polyetherketone film, a polyurethane film, etc. In this case, the film unit 10 preferably has a thickness of about 30 to 350 μm (micrometer) since the film unit 10 serves to support the light ingoing unit 20 and the light outgoing unit 30.

The light ingoing unit 20 is a part for entering light into the condensing film, and therefore the light ingoing unit 20 is formed in a lower surface of the film unit 10.

The condensing film according to the present invention has a prominence-depression pattern whose prominences are formed at constant distances, and the light ingoing unit 20 having a reflection plane 50 formed therein is provided in each of the prominences, as shown in FIG. 3. This is done to facilitate the formation of the reflection planes. When the prominence-depression pattern is formed in the light ingoing unit 20, the reflection planes 50 may be easily formed by coating the prominences with materials, such as reflectance UV ink, reflective heat-transfer film, that give reflective characteristics to a surface of the light ingoing unit 20, etc. (hereinafter, referred to as a “reflection plane material”) using a suitable tool such as a roller.

The reflection planes 50 formed thus functions to improve the use efficiency and optical characteristics of the light by cutting off light that moves along a path on which the light does not focus, and reflecting the light in a direction toward a light source. The reflection plane material preferably contains 50% or more by weight of titanium dioxide.

Also, the light ingoing unit 20 of the present invention is made of curable resin, and the curable resin is at least one selected from the group consisting of urethane acrylate, epoxyacrylate, estheracrylate and radical-forming monomer, and they may be used alone or in combinations thereof.

The use of the curable resin makes it possible to easily manufacture the light ingoing unit 20 by using a method such as molding, and form the prominence-depression pattern with desired shape, size and pitch in the light ingoing unit 20. Also, a condensing film including the light diffuser 70 may be easily manufactured using a method including: dispersing a curable resin with a light diffuser 70, molding a mixture of the curable resin and the light diffuser and curing the mixture.

Meanwhile, the light outgoing unit 30 is formed in an upper surface of the film unit 10, and generally composed of lenticular lenses. As described above, the lenticular lens functions to improve brightness (luminance) of light within a visible range by focusing the light passed through an opening of the light ingoing unit.

The lenticular lens and its manufacturing methods have been widely known in the art, and the lenticular lens of the present invention may also be manufactured according to the conventional manufacturing methods.

Meanwhile, the light outgoing unit 30 is preferably manufactured with a curable resin like the light ingoing unit 20, and the curable resin is at least one selected from the group consisting of urethane acrylate, epoxyacrylate, estheracrylate and radical-forming monomer, and they may be used alone or in combinations thereof.

In this case, the light outgoing unit 30 may be easily mass-produced through a molding process and a lens may be easily made with a desired shape, and the condensing film including a light diffuser may be easily manufactured, as described above.

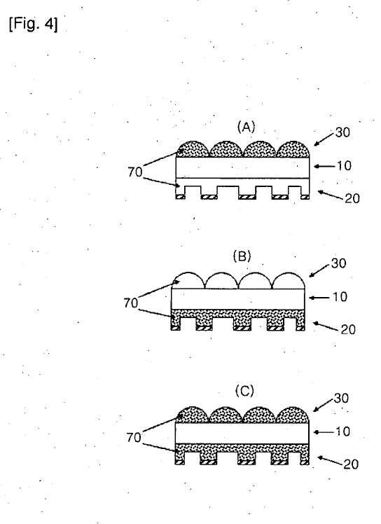

FIGS. 4A to 4C show various kinds of condensing films including light diffusers. For the condensing film according to the present invention, at least one of a film unit, a light ingoing unit and a light outgoing unit includes a light diffuser. That is to say, a light diffuser may be included in the entire region of the condensing film (not shown), or a light diffuser may also be included in some regions of the film unit, the light ingoing unit and the light outgoing unit, as shown in FIGS. 4A to 4C.

Meanwhile, a fine particle having a different refractive index relative to an inner part of the condensing film are used as the light diffuser 70, and a particle having a mean particle diameter of about 1 to 10 μm (micrometer) is preferred. There is no particular limitation on the shape of the particle, but a spherical particle is more excellent in aspect of the performances.

The light diffuser may be selected from the group consisting of polymethyl-methacrylate (PMMA), polystyrene, polybutadiene, copolymers thereof, silica, etc. Here, the light diffuser preferably has a refractive index difference of 0.01 to 0.1 relative to an inner part of the condensing film. It is generally preferred to use a material having a refractive index of about 1.48 to 1.59.

Meanwhile, the light diffuser 70 may be dispersed in a curable resin solution and used herein. The condensing film including a light diffuser may be easily manufactured by dispersing a curable resin with a light diffuser, molding a mixture of the curable resin and the light diffuser and curing the mixture. In this case, the light diffuser is preferably mixed at a content of 5 to 30 parts by weight, based on 100 parts by weight of the curable resin.

Since the condensing film configured thus uniformly scatters and reflects the incident light due to the presence of a light diffuser in the condensing film, it is possible to relieve the change in luminance of light emitted from the condensing film, and thus to relieve or prevent a hot band phenomenon that is caused by the sudden change in the luminance.

### MODE FOR THE INVENTION

Hereinafter, exemplary embodiments of the present invention will be described in detail with reference to the accompanying drawings.

### Example 1

20 g of a bead-type PMMA polymer (refractive index: 1.49, mean particle diameter: 15 μm (micrometer)) was dispersed in 100 g of a UV-curable resin having a refractive index of about 1.53 to prepare a curable resin solution. A lenticular lens and a light ingoing unit were formed respectively in upper and lower surfaces of a PET film by pouring the curable resin solution between a roller-type mold and a 125 μm (micrometer)-thick PET film and curing the curable resin solution. Then, reflection planes were formed in prominences of the light ingoing unit by coating the prominences with a reflectance ink.

### Comparative Example 1

The condensing film was manufactured in the same manner as in the Example 1, except that the bead-type PMMA polymer was not added to the curable resin solution.

### Experimental Example 1

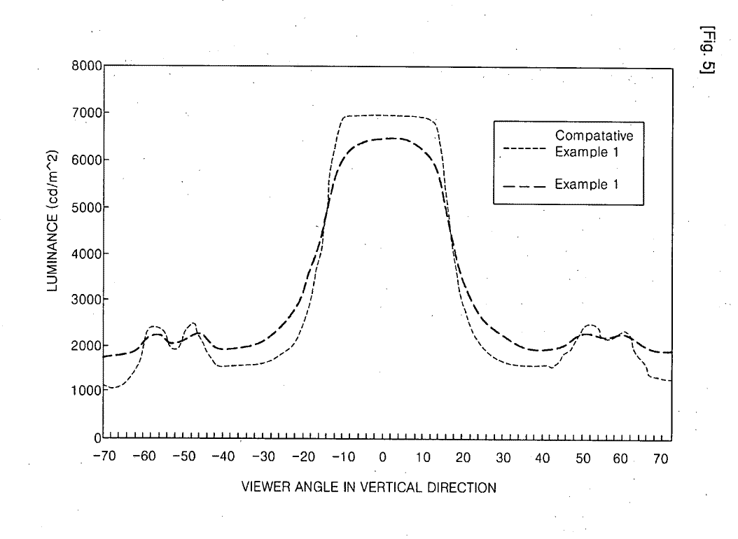

Each of the condensing film prepared in the Example 1 and Comparative example 1 was stacked onto an edge-type light guide plate using a BM7 (commercially available from Nikon) provided in a Goniometer, and measured for luminance distribution according to the viewing angle in a vertical direction. The experimental results were plotted in the graph as shown in FIG. 5.

As shown in FIG. 5, it was revealed that the condensing film of Comparative example 1 shows a sudden reduction in the luminance around a viewing angle of about ±20° (degree) but the condensing film of Example 1 shows a gentle change in the luminance around the viewing angle. Since hot bands appeared by the sudden changed in the luminance as described above, the formation of the hot bands may be reduced by using a condensing film, such as the condensing film of Example 1, that shows the gentle change in the luminance, which makes it possible to display an image with excellent image quality.

### INDUSTRIAL APPLICABILITY

As described above, an aspect of the present invention provides a backlight unit for an LCD including the above-mentioned condensing film. The backlight unit according to the present invention may be useful to improve the image quality without any diffusion film and reduce the production cost since the light diffuser in the condensing film functions to prevent a hot band phenomenon by softening the luminance distribution of the light.

1. A condensing film for an LCD backlight unit, comprising:
a film unit;
a light outgoing unit formed in an upper surface of the film unit; and
a light ingoing unit formed in a lower surface of the film unit,
wherein a light diffuser is included inside the condensing film.

2. The condensing film of claim 1, wherein the light outgoing unit is composed of lenticular lenses.

3. The condensing film of claim 1, wherein the light ingoing unit has a prominence-depression pattern whose prominences are formed at constant distances, and reflection planes are formed in the prominences.

4. The condensing film of claim 3, wherein the reflection planes contain 50% or more by weight of titanium dioxide.

5. The condensing film of claim 1, wherein the light diffuser has a mean particle diameter of 1 to 10 μm (micrometer), and has a refractive index difference of 0.01 to 0.1 relative to an inner part of the condensing film.

6. The condensing film of claim 5, wherein the light diffuser is selected from the group consisting of polymethylmethacrylate (PMMA), polystyrene, polybutadiene and copolymers thereof, and silica.

7. The condensing film of claim 1, wherein the film unit is formed of polymer films selected from the group consisting of a polyester film, a polyvinyl chloride film, a polycarbonate film, a polymethylmethacrylate film, a polystyrene film, a polyesthersulfone film, a polybutadiene film, a polyetherketone film and a polyurethane film.

8. The condensing film of claim 1, wherein the light ingoing unit and the light outgoing unit are made of curable resin.

9. The condensing film of claim 8, wherein the curable resin is selected from the group consisting of urethane acrylate, epoxyacrylate, estheracrylate and radical-forming monomer, and used alone or in combinations thereof.

10. The condensing film of claim 8, wherein the curable resin includes 5 to 30 parts by weight of a light diffuser, based on 100 parts by weight of the curable resin.

11. An LCD backlight unit having a condensing film as defined claim 1.
